(19) United States
(12) Patent Application Publication
(10) Pub. No.: US 2020/0400503 A1
(43) Pub. Date: Dec. 24, 2020

(54) FIXED MIRROR, INTERFEROMETER, AND FOURIER TRANSFORM SPECTROPHOTOMETER

(71) Applicant: Shimadzu Corporation, Kyoto (JP)

(72) Inventors: Hiromasa MARUNO, Kyoto (JP); Naoji MORIYA, Kyoto (JP); Toyoyuki HASHIMOTO, Kyoto (JP); Takashi MURAMATSU, Kyoto (JP); Hideaki KATSU, Kyoto (JP)

(21) Appl. No.: 16/447,997

(22) Filed: Jun. 21, 2019

(51) Int. Cl. G01J 3/453; G01J 3/02

(52) U.S. Cl. CPC G01J 3/4535; G01J 3/0237

(57) ABSTRACT

Provided is a fixed mirror unit capable of adjusting the inclination of a reflection surface and moving the reflection surface in a direction intersecting with the reflection surface with a simple configuration, an interferometer equipped with the fixed mirror unit, and a Fourier transform spectrophotometer. The fixed mirror unit 8 is provided with a plurality of actuators 83 for axially displacing the mirror 87. By displacing the mirror 87 by different amounts of displacements with the plurality of actuators 83, the angle of the reflection surface 87A can be adjusted, while by displacing the mirror 87 by the same amount of displacement with the plurality of actuators 83, the reflection surface 87A can be moved while keeping the angle of the reflection surface 87A constant. As a result, with a simple configuration, the angle of the reflection surface 87A can be adjusted and the reflection surface 87A can be moved along the axial direction.

### TECHNICAL FIELD

The present invention relates to a fixed mirror unit configured to reflect light from a light source and make the reflected light interfere with light reflected by a movable mirror to thereby generate interference light. It also relates to an interferometer provided with the fixed mirror unit, and a Fourier transform spectrophotometer equipped with the interferometer.

### BACKGROUND ART

An interferometer provided in a Fourier transform spectrophotometer or the like is provided with a fixed mirror unit, a movable mirror, a light source, and the like. In the interferometer, light from the light source is emitted to each of the fixed mirror unit and the movable mirror. Then, the light reflected by the fixed mirror unit and the light reflected by the movable mirror are made to interfere with each other, so that interference light is generated.

In such an interferometer, when the angle of the reflection surface of the fixed mirror unit or the angle of the reflection surface of the movable mirror deviates, the interference light changes, resulting in deteriorated performance. Under the circumstance, there has been proposed an apparatus capable of correcting the deviation when such a deviation in angle occurs (for example, see Patent Document 1 listed below).

The device described in Patent Document 1 is provided with a fixed mirror unit (mirror) capable of finely adjusting the angle (inclination) of the reflection surface. Specifically, this apparatus is provided with a base, a mirror arranged so as to be spaced apart from the base, and a plurality of electromagnet units interposed between the base and the mirror. To the center portion of the mirror, one end of an elastically deformable separation member is connected. The other end of the separation member is connected to the base. In this apparatus, an electromagnetic force is appropriately generated in a plurality of electromagnet units, so that a suction force or a repulsive force is generated between the base and the mirror. As a result, the separation member is bent, so that the angle of the mirror is finely adjusted.

### PRIOR ART

### Patent Document

Patent Document 1: Japanese Unexamined Patent Application Publication No. H02-298908

### SUMMARY OF THE INVENTION

### Problems to be Solved by the Invention

In the above-described conventional apparatus, the operation of the mirror is limited, so that the functionality of an interferometer or a Fourier transform spectrophotometer using the apparatus is limited. Specifically, in the above-mentioned conventional apparatus, the angle of the mirror is finely adjusted while keeping the distance between the center portion of the mirror and the base constant. For this reason, the mirror cannot be moved (displaced) in a direction intersecting with the reflection surface, so that the function of the interferometer or the Fourier transform spectrophotometer is limited.

For example, in some cases, so-called step scan is performed, in which interference light is emitted to a sample while moving a fixed mirror unit by a minute distance in a direction intersecting with the reflection surface (in the optical axis direction) using a Fourier transform spectrophotometer. In this step scan, an operation of slightly changing the distance between the fixed mirror unit and the movable mirror and an operation of keeping the distance between them constant for a predetermined time are repeated.

In a conventional apparatus, as described above, since the distance between the center portion of the mirror and the base is kept constant, there is a problem that the operation corresponding to the step scan cannot be performed.

The present invention has been made in view of the above situation. The present invention aims to provide a fixed mirror unit capable of adjusting inclination of a reflection surface and moving the reflection surface in a direction intersecting with the reflection surface with a simple configuration. The present invention also aims to provide an interferometer equipped with the fixed mirror unit and a Fourier transform spectrophotometer.

### Means for Solving the Problems

(1) A fixed mirror unit according to some examples of the present invention is used for an interferometer and configured to reflect light from a light source to interfere the reflected light with light from the light source reflected by a movable mirror resulting in interference light. The fixed mirror unit includes a mirror and a plurality of actuators. A reflecting surface of the mirror is configured to reflect light from the light source. Each of a plurality of actuators is configured to displace the mirror in a direction intersecting with the reflection surface. An angle of the reflection surface is adjusted by displacing the mirror by different amounts of displacements with the plurality of actuators and that the reflection surface is moved while keeping the angle of the reflection surface constant by displacing the mirror by the same amount of displacement with the plurality of actuators.

According to such a configuration, only by changing the amounts of displacements of the plurality of actuators, the reflection surface can be inclined (the angle of the reflection surface can be adjusted) and the reflection surface can be moved while keeping the angle of the reflection surface constant, e.g., by the same amount of displacements of the mirror with the plurality of actuators. Therefore, with a simple configuration, the inclination of the reflection surface can be adjusted and the reflection surface can be moved in a direction intersecting with the reflection surface.

(2) Further, the plurality of actuators may be arranged at equal intervals in a circumferential direction with respect to a center position of the reflection surface.

According to such a configuration, the adjustment of the inclination of the reflection surface and the operation of the movement of the reflection surface can be performed with higher accuracy.

(3) Further, the plurality of actuators may be each composed of a piezoelectric element.

According to such a configuration, a plurality of actuators can be easily configured. In particular, a piezoelectric element is suitably used for an interferometer because of the high speed response.

(4) Also, the fixed mirror unit may further include a flexure portion. The flexure portion connects the mirror and each of the plurality of actuators. The flexure portion is provided with a secured fixing portion, a displacement portion configured to be displaced in accordance with an operation of each of the plurality of actuators, and a beam portion which connects the fixing portion and the displacement portion and elastically displaces the displacement portion with respect to the fixing portion.

According to such a configuration, the flexure portion can be interposed between the mirror and the plurality of actuators. Since the displacement portion of the flexure portion is displaced, it is possible to perform the adjustment of the inclination of the reflection surface and the operation of the movement of the reflection surface. As a result, in the fixed mirror unit, it is possible to perform the adjustment of the inclination of the reflection surface and the operation of the movement of the reflection surface while giving certain rigidity or more.

(5) Further, the fixed mirror unit may further include an elastic hinge. The elastic hinge is interposed between the flexure portion and the mirror and elastically deformable in a direction intersecting with the reflection surface.

According to such a configuration, when the displacement portion of the flexure portion is displaced and the inclination of the reflection surface is changed, or when the displacement portion of the flexure portion is displaced and the reflection surface is moved, the elastic hinge deforms moderately. As a result, even in cases where the positional relationship (angle or distance) between the flexure portion and the mirror changes, generation of stress can be suppressed by the elastic hinge.

(6) The interferometer according to some examples of the present invention is provided with the fixed mirror unit, a movable mirror, and a light source. The movable mirror is movable by an amount of displacement larger than the amount of displacement of the mirror in the fixed mirror unit. The light source emits light to the fixed mirror unit and the movable mirror. In the interferometer, the reflected light from the fixed mirror unit and the reflected light from the movable mirror are interfered with each other to generate interference light.

According to such a configuration, in the fixed mirror unit, by performing the adjustment of the inclination of the reflection surface and the movement of the reflection surface in a direction intersecting with the reflection surface, interference light can be generated by interfering the reflected light from the fixed mirror unit with the reflected light from the movable mirror.

(7) Also, the interferometer may further include a main body and a coarse adjustment mechanism. To the main body, the fixed mirror unit and the movable mirror are attached. The coarse adjustment mechanism changes the angle of the reflection surface by adjusting an angle of the fixed mirror unit attached to the main body.

According to such a configuration, for example in cases where the angle of the reflection surface of the fixed mirror unit is largely deviated, by adjusting the angle of the fixed mirror unit with the coarse adjustment mechanism, the deviation of the angle of the reflection surface can be corrected.

(8) Further, the Fourier transform spectrophotometer according to some examples of the present invention is provided with the interferometer and a detector. The detector detects the reflected light or the transmitted light from the sample generated by irradiating the sample with the interference light from the interferometer.

According to such a configuration, it is possible to perform so-called step scan in which the interference light is irradiated to the sample while moving the fixed mirror unit in a direction intersecting with the reflection surface.

Specifically, in the interferometer, by adjusting the inclination of the reflection surface of the fixed mirror unit and moving the reflection surface of the fixed mirror unit in a direction intersecting with the reflection surface, interference light can be generated by interfering the reflected light from the fixed mirror unit with the reflected light from the movable mirror. Further, the reflected light or the transmitted light generated by irradiating the interference light to the sample can be detected by the detector.

### Effects of the Invention

According to embodiments of the present invention, only by changing the amounts of displacements of the plurality of actuators, the angle of the reflection surface can be adjusted and the reflection surface can be moved while keeping the angle of the reflection surface constant. Therefore, with a simple configuration, the angle of the reflection surface can be adjusted and the reflection surface can be moved in a direction intersecting with the reflection surface.

### EMBODIMENTS FOR CARRYING OUT THE INVENTION

### 1. Overall Configuration of Fourier Transform Spectrophotometer

A Fourier transform spectrophotometer 1 according to a first embodiment of the present invention is provided with an interferometer 2, a reflection mirror 10, a sample chamber 11, and a detector 12.

The interferometer 2 is for generating interference light, and is provided with a light source 3, a main body 4, a half mirror 5, a movable mirror 6, a drive unit 7, a fixed mirror unit 8, and a coarse adjustment mechanism 9. The light source 3 emits infrared light as measurement light. The main body 4 is formed in a hollow shape. In the main body 4, an incident port 4A and an exit port 4B are formed. The incident port 4A of the main body 4 is arranged so as to face the light source 3.

The half mirror 5 is arranged in the main body 4 so as to be spaced apart from each of the incident port 4A and the exit port 4B. The half mirror 5 is a mirror capable of reflecting a part of the incident light and transmitting the rest of the incident light.

The movable mirror 6 is arranged in the main body 4 so as to be spaced apart from the half mirror 5. The movable mirror 6 is provided with a mirror 61 and a support unit 62 supporting the mirror 61. The support unit 62 is configured to be movable along the opposing direction of the half mirror 5 and the mirror 61. The drive unit 7 is composed of, for example, a motor, and is configured to apply a driving force to the support unit 62 of the movable mirror 6. The fixed mirror unit 8 is arranged in the main body 4 so as to be spaced apart from the half mirror 5. The fixed mirror unit 8 is arranged at a fixed position in the main body 4.

The coarse adjustment mechanism 9 is provided in the main body 4. The coarse adjustment mechanism 9 is configured to correct the position of the fixed mirror unit 8 which cannot be corrected by the actuator 83 (which will be described later) of the fixed mirror unit 8 and/or the large angular displacement of the reflection surface 87A (which will be described later) of the fixed mirror unit 8. The minimum adjustment angle of the coarse adjustment mechanism 9 is required to be smaller than the angle capable of being adjusted by the actuator 83. For this reason, in the first embodiment, the coarse adjustment mechanism 9 is exemplified by a mechanism composed of a plurality of optical adjustment screws having a high definition pitch. It should be noted, however, that the coarse adjustment mechanism 9 may be composed of a screw having a coarse thread pitch by increasing the moving distance of the actuator 83 or by configuring such that a motor capable of realizing minute angle control is added. Further, it is also conceivable to realize a high angular resolution drive by adding a reduction gear to the motor. The tips of the plurality of adjustment screws are connected to the fixed mirror unit 8 (the base 81 which will be described later). The reflection mirror 10 is arranged so as to be spaced apart from the exit port 4B of the main body 4. The sample chamber 11 is arranged so as to be spaced apart from the reflection mirror 10. The sample chamber 11 is formed in a hollow box shape, and accommodates a sample therein.

The detector 12 is arranged so as to be spaced apart from the sample chamber 11. The detector 12 is composed of, for example, an MCT (HgCdTe) detector or the like. The detector 12 is configured to detect incident light and obtain a detection signal according to the detected light. Specifically, the detector 12 is configured to obtain an interferogram according to light (infrared light).

In performing an analysis of a sample using the Fourier transform spectrophotometer 1, when there is a large positional displacement in the fixed mirror unit 8 (when there is a large angular displacement in the reflection surface 87A of the fixed mirror unit 8), the positional (angular) displacement is corrected prior to the analysis. Specifically, the adjustment screw of the coarse adjustment mechanism 9 is appropriately tightened by a user, so that the fixed mirror unit 8 is pressed by the adjusting screw to correct the positional displacement of the fixed mirror unit 8.

In this way, after the positional displacement of the fixed mirror unit 8 is corrected, infrared light is emitted from the light source 3. The infrared light is introduced from the incident port 4A into the main body 4 and is incident on the half mirror 5.

The infrared light incident on the half mirror 5 is partially transmitted through the half mirror 5 and incident on the fixed mirror unit 8, and the rest of the infrared light is reflected by the half mirror 5 and incident on the movable mirror 6. At this time, in the movable mirror 6, a driving force is applied from the drive unit 7, so that the mirror 61 is moved together with the support unit 62.

The infrared light reflected by the fixed mirror unit 8 is reflected by the half mirror 5 toward the reflection mirror 10. Further, the infrared light reflected by the movable mirror 6 (mirror 61) is transmitted through the half mirror 5 toward the reflection mirror 10. As a result, the infrared light reflected by the fixed mirror unit 8 and the infrared light reflected by the movable mirror 6 are synthesized to become infrared interference light. The infrared interference light passes through the exit port 4B and is emitted to the outside of the main body 4 toward the reflection mirror 10. Then, the synthesized infrared light is reflected by the reflection mirror 10 and enters the sample chamber 11. The infrared light incident on the sample chamber 11 is irradiated on the sample in the sample chamber 11. Then, the reflected light or the transmitted light from the sample is emitted from the sample chamber 11 and is incident on the detector 12.

The detector 12 outputs interferogram corresponding to the incident infrared light as a detection signal. A control unit Fourier-transforms the interferogram output from the detector 12 to obtain intensity distribution data of the spectrum. The sample is then analyzed based on the data.

### 2. Detailed Configuration of Fixed Mirror Unit

In analyzing a sample using the Fourier transform spectrophotometer 1 described above, when deviation (small deviation) occurs in the angle of the reflection surface of the fixed mirror unit 8, the infrared interference light changes, resulting in decreased analysis accuracy. In such a case, it is necessary to finely adjust the inclination of the reflection surface of the fixed mirror unit 8. Also, in analyzing a sample using the Fourier transform spectrophotometer 1 described above, in some cases, it is desired to perform the so-called step scan in which the interference light is irradiated to the sample while moving the reflection surface of the fixed mirror unit 8 by a minute distance in a direction (optical axis direction) intersecting with the reflection surface. Therefore, in order to cope with these cases, the fixed mirror unit 8 is configured as follows.

The fixed mirror unit 8 is provided with a base 81, a plurality of (three) flexure portions 82, a plurality of (three) actuators 83, a plurality of (three) steel balls 84, a plurality of (three) elastic hinges 85, a mirror holder 86, and a mirror 87. The base 81 is a member served as a basis of the fixed mirror unit 8, and is formed in a reverse hat shape. The base 81 is provided with a center portion 811 and a flange portion 812.

The center portion 811 is formed in a cylindrical shape. In the center portion 811, a plurality of recesses 811A are formed. Each recess 811A is caved inward (downward) from one axial end surface (upper end surface) of the center portion 811. The plurality of recesses 811A is arranged at equal angular intervals in the circumferential direction of the center portion 811. In this embodiment, three recesses 811A are formed in the center portion 811 so as to be circumferentially spaced apart by about 120 degrees.

The flange portion 812 protrudes radially outward from one axial end portion (upper end portion) of the center portion 811. The flange portion 812 is formed in a step-like shape such that the thickness of its proximal end portion (inner portion) is small and the thickness of its outer portion is larger than that of the proximal end portion.

Each flexure portion 82 is fixed to one axial end surface (upper end surface) of the flange portion 812 of the base 81. Each flexure portion 82 is formed in an elongated prismatic shape and extends in the radial direction. In this embodiment, three flexure portions 82 are arranged at about 120 degree intervals in the circumferential direction. The radially inner side portion (displacement portion 822) of each flexure portion 82 overlaps with each recess 811A of the base 81 when viewed in the axial direction. Each flexure portion 82 is provided with a fixing portion 821, a displacement portion 822, and a beam portion 823. The fixing portion 821 is a radially outer side portion of the flexure portion 82 and is formed in a prismatic shape. The fixing portion 821 is fixed to one axial end surface (upper end surface) of the flange portion 812 of the base 81. Thus, each flexure portion 82 is cantilevered at the fixing portion 821. The displacement portion 822 is a radially inner side portion of the flexure portion 82, and is formed in a prismatic shape. The displacement portion 822 is arranged so as to be spaced apart from one axial end surface (upper end surface) of the flange portion 812 of the base 81.

The beam portion 823 is bridged between the fixing portion 821 and the displacement portion 822. Specifically, the beam portion 823 is provided with a portion (upper portion) bridged between one axial end portion (upper end portion) of the fixing portion 821 and the other axial end portion (upper end portion) of the displacement portion 822, and a portion (lower portion) bridged between the other axial end portion (lower end portion) of the fixing portion 821 and the other axial end portion (lower end portion) of the displacement portion 822, and connects the fixing portion 821 and the displacement portion 822 with them. The beam portion 823 is configured to be elastically deformable.

Each actuator 83 is arranged in each recess 811A of the base 81. That is, in this embodiment, three actuators 83 are arranged at about 120 degree intervals in the circumferential direction. Each actuator 83 is composed of a piezoelectric element and extends along the axial direction. One axial end portion (upper end portion) of each actuator 83 slightly protrudes from each recess 811A of the base 81. Each actuator 83 is expandable and contractible along the axial direction by being energized, and the amount of expansion or contraction (the amount of displacement) changes according to the amount of energization (voltage).

Each steel ball 84 is interposed between each actuator 83 and each flexure portion 82. A recess is formed on the other axial end surface (lower end surface) of the displacement portion 822 of each flexure portion 82, and a part of each steel ball 84 is fitted to the recess. With this, each steel ball 84 is held in a state in which each steel ball 84 is in point contact with each actuator 83.

Each elastic hinge 85 is provided on one axial end surface (upper end surface) of the displacement portion 822 of each flexure portion 82. Each elastic hinge 85 is formed in a hand drum in which its center portion is narrowed, and is provided with an axially extending columnar portion 851, a first plate portion 852 continuously connected to one axial end portion (upper end portion) of the columnar portion 851, and a second plate portion 853 continuously connected to the other axial end portion (lower end portion) of the columnar portion 851. In each elastic hinge 85, the columnar portion 851 is configured to be elastically deformable. The second plate portion 853 is fixed to one axial end surface (upper end surface) of the displacement portion 822 of each flexure portion 82.

The mirror holder 86 is formed in a disk shape and is fixed to each elastic hinge 85. Specifically, the first plate portion 852 of each elastic hinge 85 is fixed to the other axial end surface (lower end surface) of the mirror holder 86.

The mirror 87 is a disk-shaped mirror, and is fixed to one axial end surface (upper end surface) of the mirror holder 86. One axial end surface (upper end surface) of the mirror 87 is a reflection surface 87A.

With such a configuration, in the fixed mirror unit 8, the mirror 87 and the actuator 83 are connected by the flexure portion 82 via the steel ball 84, the elastic hinge 85, and the mirror holder 86. Also, between the flexure portion 82 and the mirror 87, an elastic hinge 85 (the elastic hinge 85 and the mirror holder 86) is interposed.

### 3. Operation of Fixed Mirror Unit

When finely adjusting the inclination (angle) of the mirror 87 (reflection surface 87A) of the fixed mirror unit 8, different voltages are applied to the plurality of actuators 83. Thus, each of the plurality of actuators 83 is axially displaced (expanded and contracted) by different displacement amounts. Specifically, different voltages are applied to the plurality of actuators 83 so that the amount of displacement of the actuator 83 positioned on the axial other side (lower side) of the portion of the reflection surface 87A where the change in inclination (angle) is desired to be increased becomes large and the amount of displacement of the reflection surface 87A where the change in inclination (angle) is desired to be decreased becomes small.

With this, the pressing force from the actuator 83 is applied to the displacement portion 822 of the flexure portion 82 via the steel ball 84. Then, the beam portion 823 of the flexure portion 82 is elastically deformed, so that the displacement portion 822 of the flexure portion 82 is axially displaced. At this time, since the fixing portion 821 of the flexure portion 82 is fixed to the flange portion 812 of the base 81, the fixing portion 821 is arranged at a predetermined position without being deformed. That is, in the flexure portion 82, the displacement portion 822 is elastically displaced with respect to the fixing portion 821. As described above, since each of the plurality of actuators 83 is displaced by a different amount of displacement, each of the plurality of flexure portions 82 deforms into a different shape. Specifically, the displacement portion 822 of the flexure portion 82 facing the actuator 83 having a large amount of displacement is greatly displaced, and the displacement portion 822 of the flexure portion 82 facing the actuator 83 having a small amount of displacement is slightly displaced.

Then, the mirror 87 inclines (the angle changes) together with the mirror holder 86 via the elastic hinges 85. In particular, the inclination (angle) of the mirror 87 is finely adjusted so that the portion of the mirror 87 (the mirror holder 86 and the mirror 87) corresponding to the displacement portion 822 of the flexure portion 82 with a large among of displacement is greatly inclined and the portion of the mirror 87 (the mirror holder 86 and the mirror 87) corresponding to the displacement portion 822 of the flexure portion 82 with a small amount of displacement is slightly inclined. At this time, in each elastic hinge 85, the columnar portion 851 elastically deforms while maintaining the state in which the first plate portion 852 is fixed to the mirror holder 86 and the second plate portion 853 is fixed to the flexure portion 82 (displacement portion 822). With this, each elastic hinge 85 elastically deforms in a direction intersecting with the reflection surface 87A of the mirror 87.

As described above, in the fixed mirror unit 8, the angle of the reflection surface 87A can be adjusted by displacing the mirror 87 with the plurality of actuators 83 by the respective different amounts of displacements.

For example, the mirror 87 is displaced from a first position to a second position by applying different voltages to the plurality of actuators 83 to thereby perform fine adjustment of the inclination (angle).

Also, in the case of performing so-called step scan in which the interference light is irradiated to the sample while moving the reflection surface 87A of the mirror 87 in the axial direction by a minute distance, the voltage increased or decreased by the same amount is applied to each of the plurality of the actuators 83. As a result, each of the plurality of actuators 83 is axially displaced (expanded or contracted) by the same amount of displacement.

As a result, the displacement portion 822 of each flexure portion 82 is displaced by the same amount of displacement. Thus, the mirror 87 is moved together with the mirror holder 86 along the axial direction via each elastic hinge 85. At this time, the mirror 87 is moved in the axial direction while keeping the angle of the reflection surface 87A constant.

As described above, in the fixed mirror unit 8, by displacing the mirror 87 with the plurality of actuators 83 by the same amount of displacement, the reflection surface 87A can be moved along the axial direction while keeping the angle of the reflection surface 87A constant. Note that the axial amount of displacement of the mirror 87 of the fixed mirror unit 8 is smaller than the amount of displacement of the movable mirror 6. Specifically, the amount of displacement of the movable mirror 6 is several mm to several tens of mm, whereas the amount of displacement of the mirror 87 of the fixed mirror unit 8 is several μm to several tens of μm.

For example, when the plurality of actuators 83 is axially displaced (extended or contracted) by the same amount of displacement, the mirror 87 is displaced from the position of B to the position of C while keeping the angle of the reflection surface 87A constant.

### 4. Functions and Effects

(1) In this embodiment, in the fixed mirror unit 8, the plurality of actuators 83 axially displaces the mirror 87. In the fixed mirror unit 8, by displacing the mirror 87 by different amounts of displacements with the plurality of actuators 83, the angle of reflection surface 87A can be adjusted by displacing the mirror 87 by the same amount of displacement with the plurality of actuators 83, the reflection surface 87A can be moved while keeping the angle of the reflection surface 87A constant.

For the reasons mentioned above, in the fixed mirror unit 8, the angle of the reflection surface 87A can be adjusted only by changing the amount of displacement of the plurality of actuators 83, and the reflection surface 87A can be moved along the axial direction while keeping the angle of the reflection surface 87A constant. As a result, with a simple configuration, the angle of the reflection surface 87A can be adjusted and the reflection surface 87A can be moved along the axial direction.

Further, the interferometer 2 is provided with the fixed mirror unit 8 and the movable mirror 6. Therefore, in the fixed mirror unit 8, by adjusting the angle of the reflection surface 87A and moving the reflection surface 87A along the axial direction, the reflected light from the reflection surface 87A and the reflected light from the movable mirror 6 can be interfered with each other to thereby generate interference light.

Further, the reflected light or the transmitted light generated by irradiating the interference light to the sample can be detected by the detector 12. That is, in the Fourier transform spectrophotometer 1, it is possible to perform so-called step scan in which the interference light is irradiated to the sample while moving the fixed mirror unit 8 along the axial direction.

(2) Further note that, in this embodiment, the plurality of actuators 83 is composed of piezoelectric elements.

Therefore, the plurality of actuators 83 can be easily configured. In particular, a piezoelectric element is suitably used for the interferometer 2 because of the high speed response.

(3) Further, in this embodiment, the fixed mirror unit 8 is provided with the flexure portion 82 connecting the mirror 87 and the actuator 83. The flexure portion 82 is provided with the fixing portion 821 fixed to the flange portion 812 of the base 81, the displacement portion 822 configured to be displaced in accordance with the operation of the multiple actuators 83, and a beam portion 823 which connects the fixing portion 821 and the displacement portion 822 and elastically displaces the displacement portion 822 with respect to the fixing portion 821.

Therefore, by displacing the displacement portion 822 of the flexure portion 82 in a state in which the flexure portions 82 are interposed between the mirror 87 and the plurality of actuators 83, it is possible to perform the adjustment of the inclination of the reflection surface 87A of the mirror 87 and the movement of the reflection surface 87A. As a result, in the fixed mirror unit 8, it is possible to perform the adjustment of the inclination of the reflection surface 87A and the movement of the reflection surface 87A while giving certain rigidity or more.

(4) Further, in this embodiment, the fixed mirror unit 8 is provided with a plurality of elastic hinges 85 interposed between the plurality of flexure portions 82 and the mirror 87.

For this reason, when the displacement portion 822 of the flexure portion 82 is displaced and the inclination of the reflection surface 87A is changed, or when the displacement portion 822 of the flexure portion 82 is displaced and the reflection surface 87A is moved, the elastic hinge 85 deforms moderately. As a result, even in cases where the positional relationship (angle or distance) between the flexure portion 82 and the mirror 87 changes, generation of stress can be suppressed by the elastic hinge 85.

(5) Also, in this embodiment, the fixed mirror unit 8 is provided with the coarse adjustment mechanism 9 attached to the main body 4.

Therefore, for example, in cases where the angle of the reflection surface 87A of the fixed mirror unit 8 is largely deviated, by adjusting the angle of the fixed mirror unit 8 with the coarse adjustment mechanism 9, the deviation of the reflection surface 87A can be corrected.

### 5. Second Embodiment

Hereinafter, a second embodiment of the present invention will be described. Note that the same reference numerals are allotted to the same configurations as those of the first embodiment, and the description thereof may be omitted.

In the first embodiment described above, the fixed mirror unit 8 is provided with three actuators 83. These three actuators 83 are arranged at intervals of 120 degrees in the circumferential direction. That is, when viewed in the axial direction, the plurality of actuators 83 is arranged at equal intervals in the circumferential direction with respect to the center of the reflection surface 87A of the mirror 87. Similarly, in the second embodiment, in the fixed mirror unit 8, a plurality of actuators 83 is arranged at equal intervals in the circumferential direction with respect to the center D of the reflection surface 87A of the mirror 87, but the numbers thereof are different. Thus, the number of actuators 83 can be arbitrary set as long as it is three or more.

Specifically, in the second embodiment, four recesses 811A are formed in the center portion 811 of the base 81. These four recesses 811A are arranged at intervals of 90 degrees along the circumferential direction. The actuator 83 is arranged in each of the recesses 811A. That is, in the fixed mirror unit 8, the actuators 83 are arranged at intervals of 90 degrees along the circumferential direction. Thus, in the fixed mirror unit 8, four actuators 83 are arranged symmetrically with respect to the center D of the reflection surface 87A of the mirror 87.

Also, in the fixed mirror unit 8, four flexure portions 82 are provided so as to correspond to these four actuators 83. Elastic hinges 85 are interposed between the respective flexure portions 82 and the mirror holder 86 in the same manner as in the first embodiment.

With such a configuration, the reflection surface 87A can be operated with high accuracy in the fixed mirror unit 8. For example, by operating the actuators 83A and 83B in a state in which the operations of the remaining two actuators 83 (83C and 83D) are suspended, the mirror 87 can be inclined in the X-axis direction extending in the direction connecting the actuators 83A and 83B. On the other hand, by operating the actuators 83C and 83D in a state in which the operations of the remaining two actuators 83 (83A and 83B) are suspended, the mirror 87 can be inclined in the Y-axis direction extending in the direction connecting the actuators 83C and 83D.

Also, by displacing the actuators 83A to 83D by the same amount of displacement, the reflection surface 87A can be moved along the axial direction while keeping the angle of the reflection surface 87A constant. As described above, in the second embodiment, in the fixed mirror unit 8, the plurality of actuators 83 is arranged symmetrically with respect to the center D of the reflection surface 87A. For this reason, the adjustment of the inclination of the reflection surface 87A and the operation of the movement of the reflection surface 87A can be performed with higher accuracy.

### 6. Modified Embodiment

In the above embodiment, it has been described such that the adjustment of the angle of the reflection surface 87A of the fixed mirror unit 8 with the coarse adjustment mechanism 9 is performed by the user's tightening adjustment. However, a motor for applying a driving force to the adjusting screw may be provided, and the adjusting screw may be automatically rotated by applying the driving force from the motor. That is, the adjustment of the angle of the reflection surface 87A of the fixed mirror unit 8 may be performed automatically by the coarse adjustment mechanism 9.

### DESCRIPTION OF REFERENCE SYMBOLS

1: Fourier transform spectrophotometer
2: interferometer
3: light source
4: main body
6: movable mirror
8: fixed mirror unit
9: coarse adjustment mechanism
12: detector
82: flexure portion
83: actuator
85: elastic hinge
87: mirror
87A: reflection surface
821: fixing portion
822: displacement portion
823: beam portion

1. A fixed mirror unit adjusted for an interferometer and configured to reflect light from a light source into first reflected light to interfere the first reflected light with second reflected light reflected by a movable mirror unit from the light source, resulting in interference light, the fixed mirror unit comprising:
a mirror having a reflection surface for reflecting light from the light source; and
a plurality of actuators each operable to displace the mirror in a direction intersecting with the reflection surface, the displacements of the plurality of actuators allowing the reflection surface to have an adjustable angle by different amounts of displacements of the mirror with the plurality of actuators and the reflection surface to be moved with the angle of the reflection surface kept constant by the same amount of displacements of the mirror with the plurality of actuators.

2. The fixed mirror unit as recited in claim 1,
wherein the plurality of actuators is arranged at equal intervals in a circumferential direction with respect to a center position of the reflection surface.

3. The fixed mirror unit as recited in claim 1,
wherein the plurality of actuators are each composed of a piezoelectric element.

4. The fixed mirror unit as recited in claim 1, further comprising:
a flexure portion connecting the mirror and each of the plurality of actuators,
wherein the flexure portion is provided with a secured fixing portion, a displacement portion configured to be displaced in accordance with an operation of each of the plurality of actuators, and a beam portion which connects the fixing portion and the displacement portion and elastically displaces the displacement portion with respect to the fixing portion.

5. The fixed mirror unit as recited in claim 4, further comprising:
an elastic hinge interposed between the flexure portion and the mirror and elastically deformable in a direction intersecting with the reflection surface.

6. An interferometer comprising:
the fixed mirror unit as recited in claim 1;
a movable mirror unit movable by an amount of displacement larger than an amount of displacement of the mirror in the fixed mirror unit; and
a light source configured to emit light to the fixed mirror unit and the movable mirror unit,
wherein the reflected light from the fixed mirror unit and the reflected light from the movable mirror unit are interfered with each other to generate interference light.

7. The interferometer as recited in claim 6, further comprising:
a main body to which the fixed mirror unit and the movable mirror unit are attached; and
a coarse adjustment mechanism configured to change the angle of the reflection surface by adjusting an angle of the fixed mirror unit attached to the main body.

8. A Fourier transform spectrophotometer, comprising:
the interferometer as recited in claim 6; and
a detector configured to detect reflected light or transmitted light from a sample generated by irradiating the sample with interference light from the interferometer.
